(19) United States
(12) Patent Application Publication
(10) Pub. No.: US 2023/0227306 A1
(43) Pub. Date: Jul. 20, 2023

(54) HYDROGEN STORAGE BY MEANS OF DERIVATIVES OF COMPOUNDS OF RENEWABLE ORIGIN

(71) Applicant: ARKEMA FRANCE, COLOMBES (FR)

(72) Inventors: Jean-Luc DUBOIS, COLOMBES CEDEX (FR); Bernard MONGUILLON, COLOMBES CEDEX (FR)

(21) Appl. No.: 17/999,063

(22) PCT Filed: Oct. 7, 2021
(86) PCT No.: PCT/FR2021/051739

§ 371 Date: Nov. 17, 2022

(30) Foreign Application Priority Data
Oct. 8, 2020 (FR) FR2010281

(51) Int. Cl. C01B 3/00

(52) U.S. Cl. CPC C01B 3/0015

(57) ABSTRACT

The present invention relates to the use of a formulation which is liquid at ambient temperature comprising at least one terpene derivative for the fixing and the release of hydrogen in at least one hydrogenation/dehydrogenation cycle of said formulation.

The invention also relates to the use of said formulation for the transportation and the handling of hydrogen resulting from the steam cracking of petroleum products, of inevitable hydrogen resulting from chemical reactions, such as the electrolysis of salt, or of hydrogen resulting from the electrolysis of water.

The present invention relates to the field of the storage and transportation of an energy source and more particularly to that of the storage and transportation of hydrogen as an energy source, and in particular to that of organic compounds capable of storing and transporting hydrogen.

The storage and transportation of hydrogen by means of organic compounds is a recent technology which has for some years been the subject of publications in the scientific literature and of filings of patent applications. The principle consists in fixing hydrogen on a support molecule, which support molecule is preferably and most often liquid at ambient temperature, both when it has fixed the hydrogen (hydrogenated form) and when it has released the hydrogen (dehydrogenated form).

The fixation of hydrogen is generally carried out during a stage of hydrogenation of the support molecule. The support molecule, thus hydrogenated, “stores” the fixed hydrogen and this molecule, referred to as “hydrogenated”, can be stored and/or transported. The fixed hydrogen can subsequently be released, most often close to the site of consumption, in a stage of dehydrogenation of the hydrogenated support molecule.

Support molecules are today the subject of numerous studies and are now better known under the acronym LOHC for “Liquid Organic Hydrogen Carrier”.

Mention may be made, among the most studied LOHCs today, of toluene, which can be hydrogenated to give methylcyclohexane and then dehydrogenated. One of the problems encountered with this molecule is its relatively low boiling point (110.6° C. at atmospheric pressure, admittedly higher than that of the hydrogenated form, methylcyclohexane: 100.85° C.), which can result in the production of hydrogen containing traces of toluene and/or methylcyclohexane, which can be difficult to get rid of.

The traces of organic compounds in the hydrogen released during the dehydrogenation reaction can pose a real problem depending on the applications envisaged and the fields of application where the hydrogen is used. In the case of the toluene/methylcyclohexane pair, the traces of organic compounds can thus come both from toluene (molecule in hydrogenated form) and from methylcyclohexane (molecule in dehydrogenated form), but also from all their partially hydrogenated or dehydrogenated intermediates.

Other LOHCs known today are aromatic fluids having two or three rings, represented in particular by benzyltoluene (BT) and/or dibenzyltoluene (DBT) and which have already been the subject of numerous studies and patent applications, such as, for example, the patent EP 2 925 669, which describes the technology and the operations for hydrogenation and dehydrogenation of these fluids for the storage and the release of hydrogen. Still other LOHC compounds are under study and examples are presented in the paper by Päivi et al. (Journal of Power Sources, 396, (2018), 803-823).

Beyond the instantaneous performance quality of the hydrogenation and dehydrogenation stages, the sequence of the cycles and the maintenance of the performance qualities (hydrogen fixation/release yield) and also the quality of the hydrogen obtained during the dehydrogenation stage are key points as regards the economic aspect of this technology.

This is because the hydrogen resulting from this LOHC technology finds uses in a great many fields, such as, for example, in fuel cells, in industrial processes, or also as fuel for transportation means (trains, boats, trucks, motor cars). Any impurity potentially harmful to the environment and present in the hydrogen resulting from the reaction for dehydrogenation, whether total or partial, of the LOHC molecule, even in trace amounts, might have a negative impact both on the hydrogenation/dehydrogenation process in terms of yield, on the quality of the products manufactured or also on the yields in the end uses of the hydrogen produced by this technique.

In point of fact, the LOHC compounds known and under development today and listed above are compounds derived from products of fossil origin or synthesized from products of fossil origin. Specifically, the LOHCs known today, such as toluene, benzene and their di- or trimerized derivatives, such as benzyltoluene (BT) and dibenzyltoluene (DBT), as well as aromatics possibly carrying heteroatoms, in particular indole derivatives and carbazole derivatives, are all products derived from oil, some of which may exhibit a degree of toxicity, indeed even be harmful with regard to the environment. In addition, they are of nonrenewable origin and may be subject to the vagaries of price variations in the costs of crude oil.

There consequently remains a need for more environmentally friendly LOHC molecules exhibiting hydrogen transportation capacities at least equivalent to those of LOHC molecules of nonrenewable origin. Another objective is to provide more environmentally friendly LOHC molecules which are compatible with the hydrogenation and dehydrogenation reactions making possible the transportation of hydrogen efficiently and under safe conditions.

It has been discovered, surprisingly, that the abovementioned objectives can be achieved, in all or at least in part, by the present invention. Yet further objectives may become apparent in the description of the present invention which follows.

Specifically, the inventors have now discovered that certain products of natural origin, also called of renewable origin, can advantageously be used, directly or indirectly (that is to say, after possible chemical modification), in LOHC formulations. This is because these products of natural origin exhibit the advantage of not being derived from oil, of not depending on fluctuations in the price of crude oil, and of exhibiting at least one molecular structure capable of being hydrogenated and then dehydrogenated under the same conditions as the LOHC molecules resulting from oil and known today.

Thus, a first subject matter of the present invention is the use of a formulation which is liquid at ambient temperature comprising at least one terpene derivative for the fixing and the release of hydrogen in at least one hydrogenation/dehydrogenation cycle of said formulation.

Within the meaning of the present invention, the term “terpene derivative” is understood to mean a product of renewable origin comprising at least one hydrocarbon ring comprising 6 carbon atoms and capable of being hydrogenated and/or dehydrogenated.

The invention uses products of renewable origin as starting products. The carbon of a product of renewable origin comes from the photosynthesis of plants and thus from atmospheric CO₂. The term “biocarbon” indicates that the carbon is of renewable origin and originates from a biomaterial, as indicated below. Biocarbon content and biomaterial content are expressions denoting the same value.

A material of renewable origin, also called biomaterial, is an organic material in which the carbon originates from CO₂ fixed recently (on a human timescale) by photosynthesis from the atmosphere. On land, this CO₂ is captured or fixed by plants. At sea, the CO₂ is captured or fixed by bacteria, cyanobacteria, algae or plankton carrying out photosynthesis.

A biomaterial (100% natural-origin carbon) exhibits a ¹⁴C/¹²C isotopic ratio of greater than 10⁻¹², typically of the order of 1.2×10⁻¹², whereas a fossil material has a zero ratio. This is because the ¹⁴C isotope forms in the atmosphere and is subsequently incorporated by photosynthesis, on a timescale of a few decades at most. The half-life of ¹⁴C is 5730 years. Thus, materials resulting from photosynthesis, namely plants generally, necessarily have a maximum content of isotope ¹⁴C. Beyond 50,000 years, the ¹⁴C content becomes difficult to detect.

The biomaterial content or biocarbon content is determined by application of the standards ASTM D 6866 (ASTM D 6866-06) and ASTM D 7026 (ASTM D 7026-04). The object of the standard ASTM D 6866 is “Determining the Biobased Content of Natural Range Materials Using Radiocarbon and Isotope Ratio Mass Spectrometry Analysis”, while the object of the standard ASTM D 7026 is “Sampling and Reporting of Results for Determination of Biobased Content of Materials via Carbon Isotope Analysis”. The second standard references the first in its first paragraph.

The first standard describes a test for measuring the ¹⁴C/¹²C ratio of a sample and compares it with the ¹⁴C/¹²C ratio of a reference sample of 100% renewable origin, to give a relative percentage of carbon of renewable origin in the sample. The standard is based on the same concepts as ¹⁴C dating, but without applying the dating equations.

The ratio thus calculated is denoted as the “pMC” (percent Modern Carbon). If the material under analysis is a mixture of biomaterial and fossil material (with no radioactive isotope), then the pMC value obtained is directly correlated to the amount of biomaterial present in the sample. The reference value used for ¹⁴C dating is a value dating from the 1950s. This year was chosen due to the existence of nuclear tests in the atmosphere which introduced large amounts of isotopes into the atmosphere after this date. The 1950 reference corresponds to a pMC value of 100. Taking into account the thermonuclear tests, the current value to be retained is approximately 107.5 (which corresponds to a correction factor of 0.93). The radioactive carbon signature of a present-day plant is thus 107.5. Signatures of 54 pMC and of 99 pMC thus correspond to an amount of biomaterial in the sample of 50% and of 93%, respectively.

The standard ASTM D 6866 provides three techniques for measuring the content of ¹⁴C isotope:
LSC (Liquid Scintillation Counting) liquid scintillation spectrometry: this technique consists of counting “β” particles resulting from the disintegration of ¹⁴C; the β radiation resulting from a sample of known mass (known number of C atoms) is measured for a certain time; this “radioactivity” is proportional to the number of ¹⁴C atoms, which can thus be determined; the ¹⁴C present in the sample emits β radiation, which, on contact with the liquid scintillant (scintillator), gives rise to photons; these photons have different energies (between 0 and 156 keV) and form what is called a ¹⁴C spectrum; according to two alternative forms of this method, the analysis relates either to CO₂ produced beforehand by the carbon sample in an appropriate absorbent solution, or to benzene after prior conversion of the carbon sample into benzene. The standard ASTM D 6866 thus gives two methods A and C, based on this LSC method; AMS/IRMS (Accelerated Mass Spectrometry coupled with Isotope Ratio Mass Spectrometry): in this technique, based on mass spectrometry, the sample is reduced to graphite or to CO₂ gas, then analyzed in a mass spectrometer; this technique uses an accelerator and a mass spectrometer to separate the ¹⁴C ions from the ¹²C ions and to thus determine the ratio of the two isotopes.

The terpene derivatives which can be used in the context of the present invention originate at least in part from biomaterial and thus exhibit a biomaterial content of at least 1%. This content is advantageously higher, in particular of at least 20%, better still of at least 40%, advantageously of at least 50%, indeed even up to 100%. The terpene compounds which can be used in the context of the present invention can thus comprise 100% biocarbon or, on the contrary, result from a mixture or from products of reaction(s) with one or more other compounds of fossil origin.

For the requirements of the present invention, preference is given to the formulations comprising at least one terpene derivative in which the (number of carbon atoms of renewable origin/total number of carbon atoms) ratio is greater than or equal to 20%, preferably greater than or equal to 30%, preferably greater than or equal to 40% and entirely preferably greater than or equal to 50%.

More specifically, and according to an embodiment of the present invention, the term “terpene derivative” is understood to mean an organic compound comprising at least one carbon backbone of formula (1):

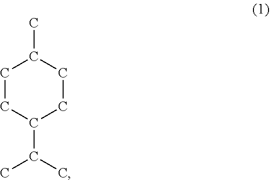

in which each “C” represents a carbon atom, bonded to at least one other carbon atom, the total number of carbon atoms being 10, said carbon backbone of formula (1) not showing the hydrogen atom(s) and/or other substituents, nor the possible unsaturation(s) in the form of double or triple bond(s) or other possible fused and/or condensed ring(s).

The possible substituents can be chosen from:
a saturated or unsaturated, linear, branched or cyclic, hydrocarbon radical comprising from 1 to 30 carbon atoms, optionally including one or more heteroatom(s) chosen from oxygen, sulfur and nitrogen, a halogen atom chosen from fluorine, chlorine, bromine and iodine, and an —OH, —OR, —NH₂, —NHR, —NRR′, —SH or —SR radical, where R and R′ each represents, independently of one another, a saturated or unsaturated, linear, branched or cyclic, hydrocarbon chain comprising from 1 to 10 atoms of carbon.

As indicated above, the backbone of formula (1) can appear in any type of molecule and in particular the molecules carrying one or more fused and/or condensed rings. Thus, the backbone of formula (1), also called “having a limonene structure” in the continuation of the present description, can also appear, inter alia and by way of nonlimiting examples, in the forms of backbones of following structures (1′) and (17

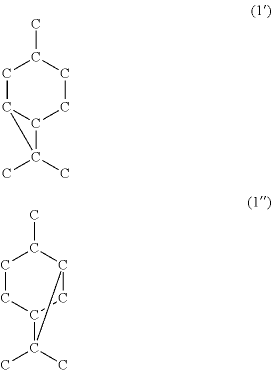

backbones of formula (1′) and (1″) also referred to respectively as “having a carene structure” and “having a pinene structure” in the continuation of the present account.

Terpene derivatives having a carene structure or having a pinene structure are, however, not preferred for the use according to the present invention, although they are not excluded therefrom.

Other compounds of renewable origin comprising the backbone of formula (1) defined above additionally comprise one or more other fused or condensed ring(s), optionally carrying heteroatom(s), forming, for example, ether, amine and other functions, it being possible for these functions to be intramolecular.

By way of illustrative examples, and without making any limitation to the invention, the terpene derivatives which can advantageously be present in the formulation as such or by chemical reaction between two or more of them and/or with other molecules of renewable or nonrenewable origin, as indicated below, can in particular be chosen from: limonene, including its enantiomeric forms and its racemate (1-methyl-4-(1-methylvinyl)cyclohexene, CAS 7705-14-8, 138-86-3; 5989-27-5; 5989-54-8), terpinenes (including α-terpinene, β-terpinene, γ-terpinene) and terpinolenes, including their monohydroxylated and dihydroxylated forms, para-cymene (CAS 99-87-6) and its hydroxylated derivatives carvacrol and thymol, eucalyptol or cineol (having an intramolecular cyclic ether function), -pinenes, comprising α-pinene (CAS 7785 4) and β-pinene (CAS 127-91-3), and also their hydroxylated derivatives, such as borneol, carenes (3,7,7-trimethylbicyclo[4,1,0]heptene) and in particular Δ³-carene (CAS 13466-78-9), cadalanes (4,7-dimethyl-1-propan-2-yl-perhydronaphthalene), cadinenes (4,7-dimethyl-1-propan-2-yl-1,2,4a,5,8,8a-hexahydronaphthalene, CAS 29350-73-0), including their α-, β-, γ-, δ- and ε-stereoisomers, cannabinol and its derivatives, such as tetrahydrocannabinol, cannabidiol, cannabitriol, and others, as well as the mixtures of two or more of them.

Such products are mostly present in products of natural origin, in particular in plants, whether terrestrial, marine, indeed even submarine, in particular in trees, conifers, flowers, leaves, wood, fruits and others, from where they can be extracted by any means known per se, and using known or adapted procedures available in the scientific literature, the patent literature or also on the Internet.

Examples of plants comprising the terpene derivatives which can be used in the context of the present invention comprise, in an illustrative but nonlimiting way, sage, rosemary, lavender, pepper, clove, hemp, cannabis, camphor, hops, cinnamon, basil, oregano, citrus fruits (lemon, orange, citron), mint, peppermint, juniper, cade juniper, ginger, ginseng, bay leaf, lemon grass, mango, dill, parsley, thyme, watercress, monarda, savory, marjoram, dittany, eucalyptus, tea tree, cumin, artemisia, absinthe, and others . . . .

For the requirements of the present invention, it is of course possible to use a single terpene derivative or also mixtures of two, three, four, indeed even more, terpene derivatives as they have just been defined, in all proportions and with various degrees of hydrogenation, that is to say completely or partially hydrogenated and/or completely or partially dehydrogenated.

Finally, it can be useful or even advantageous to carry out one or more purification operations on the terpene derivative(s), according to any method well known to a person skilled in the art, in particular to avoid contamination of the hydrogen which will be produced during the dehydrogenation of said terpene derivative, to avoid the passivation of the catalysts during the hydrogenation and dehydrogenation operations, to improve the yields of the hydrogenation and dehydrogenation reactions, to increase the lifetime (number of cycles of the hydrogenation and dehydrogenation reactions) of the terpene derivative or mixtures of terpene derivatives used as LOHC.

The terpene derivatives as they have been defined above are known and readily available commercially, for example from players in the sectors of agriculture and wood and their byproducts, or prepared by metabolic routes in microorganisms, or also more simply from known procedures available in the scientific literature, the patent literature or also on the Internet.

The molecules referred to as LOHC molecules are often characterized by their Theoretical Gravimetric Storage Capacity (TGSC). The theoretical gravimetric storage capacity of a hydrogen absorption system (LOHC+/LOHC− pair), in which the hydrogen is stored in the mass of the material, is calculated from the ratio of the weight of hydrogen stored in the compound with respect to the weight of the host including the hydrogen (LOHC+), so that the capacity in % by weight, TGSC, is given by the following formula:

$$T G S C = \frac{( molar mass of releasable hydrogen )}{( molar mass of the host in its completely hydrogenated form )} \times 100$$

For example, 1-methyl-4-isopropylcyclohexane can theoretically be completely dehydrogenated to give para-isopropenyltoluene with the release of 8 hydrogen atoms, as illustrated below:

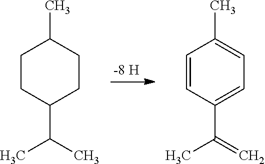

Thus, the theoretical gravimetric storage capacity TGSC of the 1-methyl-4-isopropylcyclohexane/para-isopropenyltoluene system is equal to:

$$T G S C = \frac{8}{140} \times 100 = 5 \text{.71} \%$$

In the above example, the starting terpene derivative is cymene which has been completely hydrogenated and then theoretically completely dehydrogenated with the release of 8 hydrogen atoms. It will thus be indicated in the context of the present invention that cymene exhibits a TGSC of 5.71%.

In the present invention, it should be understood that the terpene derivatives can be used as LOHC compounds, that is to say be subjected to one or more, and preferably several, hydrogenation/dehydrogenation cycles, it being possible for these hydrogenation and dehydrogenation reactions to be carried out, without distinction and independently of each other, completely or partially, according to the wish of the operator, and/or according to the molecules used, and/or according to the operating conditions employed.

According to a preferred embodiment of the invention, the terpene derivatives which can be used in the context of the present invention exhibit a TGSC of strictly greater than 0%, preferably of greater than or equal to 1%, better still of greater than or equal to 2%, more preferably of greater than or equal to 3%, advantageously of greater than or equal to 4% and very advantageously of greater than or equal to 5%.

In certain cases, and according to an embodiment of the present invention, it can be advantageous to modify, for example increase, the TGSC of the LOHCs, and more advantageously while maintaining a ratio of carbon of renewable origin of greater than or equal to 20%, as indicated above. It is consequently possible to envisage causing the terpene derivatives to react chemically with one another and/or with other molecules of renewable or nonrenewable origin, for example molecules resulting from petrochemicals, in particular aromatic compounds resulting from petrochemicals, such as benzene, toluene, xylenes, benzene/toluene/xylene mixtures better known under the names of BTX, polyethylbenzene residues better known under the name PEBR, and also their mixtures in all proportions, to mention only the commonest.

By way of example, it is thus possible to carry out couplings starting from halogenated, in particular chlorinated, or hydroxylated derivatives, according to procedures well known to a person skilled in the art and in particular those described in the patent DE2840272 A1, in the publication by Maria Sol Marques da Silva et al., Reactive Polymers, 25, (1995), 55-61, or also more recently in the paper by Taiga Yurino et al., European Journal of Organic Chemistry, (2020), 2020(15), 2225-2232.

Thus, an example of coupling can be carried out between cymene and benzyl chloride to result in a new LOHC terpene derivative with a TGSC equal to 5.9%:

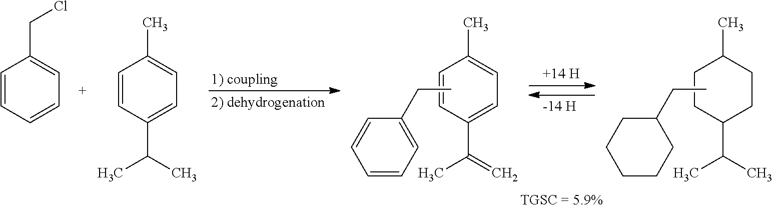

According to another example, it is possible to carry out a coupling between cymene and tolyl chloride to result in another new LOHC terpene derivative, the TGSC of which exhibits the same value of 5.9%:

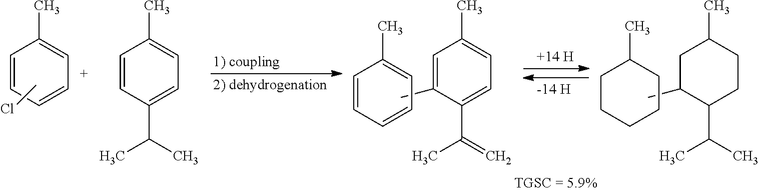

In one embodiment of the present invention, preference is given to terpene derivatives exhibiting (in their theoretically completely dehydrogenated form) at least two six-membered rings, preferably at least two six-membered carbon rings, more preferably at least two aromatic rings having six carbon atoms.

The invention thus relates to the use of a formulation which is liquid at ambient temperature, in its partially or completely dehydrogenated form, as in its partially or completely hydrogenated form, comprising one or more terpene derivatives as they have just been defined for the fixing and the release of hydrogen in at least one partial or complete hydrogenation/dehydrogenation cycle of said formulation.

The formulation which can be used in the context of the present invention can additionally comprise one or more other LOHCs known to a person skilled in the art, such as, for example, chosen from toluene, benzyltoluene (BT), dibenzyltoluene (DBT) and their mixtures in all proportions.

The formulation which can be used in the present invention can additionally comprise one or more additive(s) and/or filler(s) also well known to a person skilled in the art and, for example, and in a nonlimiting way, chosen from antioxidants, passivators, pour point depressants, decomposition inhibitors, colorants, aromas, and the like, and also the mixtures of one or more of them in all proportions.

According to another embodiment, and according to the requirements in particular in terms of purity of hydrogen to be released, the formulation comprises only (partially or completely) hydrogenatable/dehydrogenatable compounds; in particular, the formulation consists of LOHC molecules, without other added products of additive or filler types. The formulation may, however, contain impurities, preferably in trace form, in particular inherent in the origin of the LOHC molecule used and/or its process of preparation.

According to a preferred embodiment of the present invention, the formulation exhibits a boiling point of greater than 150° C. at atmospheric pressure, preferably of greater than 180° C. at atmospheric pressure, and a melting point of less than 40° C., preferably of less than 30° C., more preferably of less than 20° C., better still of less than 15° C., and entirely preferably a melting point of less than 10° C. and advantageously of strictly less than 0° C.

According to another embodiment, the formulation used in the present invention exhibits a kinematic viscosity at 20° C. (measured according to the standard DIN 51562) of between 0.1 mm²·s⁻¹ and 500 mm²·s⁻¹, preferably between 0.5 mm²·s⁻¹ and 300 mm²·s⁻¹ and preferably between 1 mm²·s⁻¹ and 200 mm²·s⁻¹.

According to yet another embodiment, the flash point of the formulation comprising at least one terpene derivative according to the invention exhibits a flash point of greater than 10° C., preferably of greater than 20° C., measured according to the standard NF EN 22-592.

In a very particularly preferred embodiment of the invention, the formulation, and in particular each of the elements which compose it, exhibits a decomposition temperature of greater than 250° C. and advantageously does not decompose to more than 0.1% by weight, when said formulation is maintained at a temperature of 300° C. for 4 hours, at atmospheric pressure. This precaution makes it possible to envisage a maximum rate of reuse of the LOHC formulation, which is intended to be the subject of as great a number as possible of hydrogenation/dehydrogenation cycles, for example at least 50 times, advantageously at least 100 times, more advantageously at least 250 times, thus making possible the storage and transportation of hydrogen with said formulation.

The hydrogenation/dehydrogenation cycles are generally carried out according to methods which are now well known. In particular, the dehydrogenation reaction can be carried out according to any known method, by applying one or more of the following operating conditions, which operating conditions are listed below by way of nonlimiting examples:
reaction temperature generally of between 200° C. and 350° C., preferably between 250° C. and 330° C., more preferably between 280° C. and 320° C., more preferentially between 280° C. and 330° C. and completely preferably between 280° C. and 320° C.,
   reaction pressure generally of between 0.001 MPa and 0.3 MPa and preferably between 0.01 MPa and 0.2 MPa, and more preferably the reaction pressure is atmospheric pressure,
   feeding the dehydrogenation reactor with a partial hydrogen pressure, —halting the reaction before complete dehydrogenation of the compound(s) to be dehydrogenated.

The reaction is generally and advantageously carried out in the presence of at least one dehydrogenation catalyst well known to a person skilled in the art. Mention may be made, among the catalysts which can be used for said partial dehydrogenation reaction, by way of nonlimiting examples, of heterogeneous catalysts containing at least one metal on a support. Said metal is chosen from the metals of columns 3 to 12 of the Periodic Table of the Elements of the IUPAC, that is to say from the transition metals of said periodic table. In a preferred embodiment, the metal is chosen from the metals of columns 5 to 11, more preferentially of columns 5 to 10, of the Periodic Table of the Elements of the IUPAC.

The metals of these catalysts are generally chosen from iron, cobalt, copper, titanium, molybdenum, manganese, nickel, platinum and palladium, and their mixtures. The metals are preferably chosen from copper, molybdenum, platinum, palladium and the mixtures of two or more of them in all proportions.

The support of the catalyst can be of any type well known to a person skilled in the art and is advantageously chosen from porous supports, more advantageously from porous refractory supports. Nonlimiting examples of supports comprise alumina, silica, zirconia, magnesia, beryllium oxide, chromium oxide, titanium oxide, thorium oxide, ceramic, carbon, such as carbon black, graphite and activated carbon, and also their combinations. Mention may be made, among the specific and preferred examples of a support which can be used in the process of the present invention, of amorphous aluminosilicates, crystalline aluminosilicates (zeolites) and supports based on silica-titanium oxide.

The hydrogenation reaction can also be carried out for its part according to any method well known to a person skilled in the art on a formulation comprising at least one terpene derivative as defined above.

The hydrogenation reaction is generally carried out at a temperature of between 100° C. and 200° C., preferably between 120° C. and 180° C. and more preferably from 140° C. to 160° C. The pressure employed for this reaction is generally between 0.1 MPa and 5 MPa, preferably between 0.5 MPa and 4 MPa and more preferably between 1 MPa and 3 MPa.

The hydrogenation reaction is generally carried out in the presence of a catalyst and more particularly of a hydrogenation catalyst well known to a person skilled in the art and advantageously chosen from, by way of nonlimiting examples, heterogeneous catalysts containing metals on a support. Said metal is chosen from the metals of columns 3 to 12 of the Periodic Table of the Elements of the IUPAC, that is to say from the transition metals of said periodic table. In a preferred embodiment, the metal is chosen from the metals of columns 5 to 11, more preferentially of columns 5 to 10, of the Periodic Table of the Elements of the IUPAC.

The metals of these hydrogenation catalysts are generally chosen from iron, cobalt, copper, titanium, molybdenum, manganese, nickel, platinum and palladium, and their mixtures. The metals are preferably chosen from copper, molybdenum, platinum, palladium and the mixtures of two or more of them in all proportions.

The support of the catalyst can be of any type well known to a person skilled in the art and is advantageously chosen from porous supports, more advantageously from porous refractory supports. Nonlimiting examples of supports comprise alumina, silica, zirconia, magnesia, beryllium oxide, chromium oxide, titanium oxide, thorium oxide, ceramic, carbon, such as carbon black, graphite and activated carbon, and also their combinations. Mention may be made, among the specific and preferred examples of a support which can be used in the process of the present invention, of amorphous aluminosilicates, crystalline aluminosilicates (zeolites) and supports based on silica-titanium oxide.

According to a preferred embodiment, the hydrogenation reaction is carried out on a completely or partially dehydrogenated formulation, for example at least partially dehydrogenated, in one or more hydrogenation/dehydrogenation cycles.

Similarly, the hydrogenation reaction can be partial or complete and preferably the hydrogenation reaction is complete in one or more hydrogenation/dehydrogenation cycles, that is to say that all of the double bonds capable of being hydrogenated present in the LOHC formulation are completely hydrogenated.

According to another aspect, the present invention relates to a hydrogenation/dehydrogenation cycle comprising a partial or complete dehydrogenation reaction of an LOHC formulation as has just been defined and at least one partial or complete hydrogenation reaction of said organic liquid.

According to a very particularly preferred aspect of the invention, the boiling point of said LOHC formulation is greater than the temperature required for the dehydrogenation stage, this being the case in order to obtain the purest possible hydrogen in gaseous form.

In the LOHC application, the formulations for the transportation of hydrogen, the use of which is the subject matter of the present invention, are very particularly well suited because of their stability, which makes possible reuse in a large number of hydrogenation/dehydrogenation cycles for the transportation and the handling of hydrogen resulting from the steam cracking of petroleum products, of inevitable hydrogen resulting from chemical reactions, such as the electrolysis of salt, or of hydrogen resulting from the electrolysis of water.

1-10. (canceled)

11. A method of storing hydrogen comprising fixing the hydrogen with a formulation which is liquid at ambient temperature comprises at least one terpene derivative for the fixing and the release of the hydrogen in at least one hydrogenation/dehydrogenation cycle of said formulation.

12. The method as claimed in claim 11, in which the terpene derivative is a product of renewable origin comprising at least one hydrocarbon ring comprising 6 carbon atoms and capable of being hydrogenated and/or dehydrogenated.

13. The method as claimed in claim 11, in which the terpene derivative is an organic compound comprising at least one carbon backbone of formula (1): 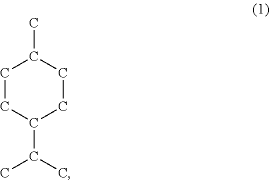
in which each “C” represents a carbon atom, bonded to at least one other carbon atom, the total number of carbon atoms of the backbone of formula (1) being 10, said carbon backbone of formula (1) not showing the hydrogen atom(s) and/or other substituents, nor the possible unsaturation(s) in the form of double or triple bond(s) or other possible fused and/or condensed ring(s).

14. The method as claimed in any claim 11, in which the terpene derivative present in the formulation as such or by chemical reaction between two or more of them and/or with other molecules of renewable or nonrenewable origin is selected from the group consisting of: limonene, including its enantiomeric forms and its racemate (1-methyl-4-(1-methylvinyl)cyclohexene, CAS 7705-14-8, 138-86-3; 5989-27-5; 5989-54-8), terpinenes (including α-terpinene, β-terpinene, γ-terpinene) and terpinolenes, including their monohydroxylated and dihydroxylated forms, para-cymene (CAS 99-87-6) and its hydroxylated derivatives carvacrol and thymol, eucalyptol or cineol, pinenes, comprising α-pinene (CAS 7785-26-4) and β-pinene (CAS 127-91-3), and also their hydroxylated derivatives, carenes (3,7,7-trimethylbicyclo [4,1,0]heptene) and in particular Δ³-carene (CAS 13466-78-9),cadalanes (4,7-dimethyl-1-propan-2-yl-perhydronaphthalene), cadinenes (4,7-dimethyl-1-propan-2-yl-1,2,4a,5,8,8α-hexahydronaphthalene, CAS 29350-73-0), including their α-, β-, γ-, δ- and ε-stereoisomers, cannabinol and its derivatives, such as tetrahydrocannabinol, cannabidiol, cannabitriol, and others, as well as the mixtures of two or more of them.

15. The method as claimed in claim 11, in which the terpene derivative originates from terrestrial, marine or submarine plants.

16. The method as claimed in claim 11, in which the terpene derivative originates from plants selected from the group consisting of sage, rosemary, lavender, pepper, clove, hemp, cannabis, camphor, hops, cinnamon, basil, oregano, citrus fruits (lemon, orange, citron), mint, peppermint, juniper, cade juniper, ginger, ginseng, bay leaf, lemon grass, mango, dill, parsley, thyme, watercress, monarda, savory, marjoram, dittany, eucalyptus, tea tree, cumin, artemisia, and absinthe.

17. The method as claimed in claim 11, in which the formulation additionally comprises one or more other LOHCs and their mixtures in all proportions.

18. The method as claimed in claim 11, in which the formulation exhibits a boiling point of greater than 150° C., at atmospheric pressure and a melting point of less than 40° C.

19. The method as claimed in claim 11, in which the formulation exhibits a kinematic viscosity at 20° C. (measured according to the standard DIN 51562) of between 0.1 mm²·s⁻¹ and 500 mm²·s⁻¹.

20. The method as claimed in claim 11, for the transportation and the handling of hydrogen resulting from the steam cracking of petroleum products, of inevitable hydrogen resulting from chemical reactions, such as the electrolysis of salt, or of hydrogen resulting from the electrolysis of water.
